(19) United States
(12) Patent Application Publication
(10) Pub. No.: US 2024/0265814 A1
(43) Pub. Date: Aug. 8, 2024

(54) SYSTEM AND METHODS FOR IMPROVED SITUATIONAL AWARENESS IN AVIATION

(71) Applicant: Wisk Aero LLC, Mountain View, CA (US)

(72) Inventor: Robert Gettler, JR., Dunedin, FL (US)

(73) Assignee: Wisk Aero LLC, Mountain View, CA (US)

(21) Appl. No.: 18/435,219

(22) Filed: Feb. 7, 2024

Related U.S. Application Data
(60) Provisional application No. 63/444,194, filed on Feb. 8, 2023.

(51) Int. Cl. G08G 5/00; G06F 3/04817

(52) U.S. Cl. CPC G08G 5/0026; G06F 3/04817; G08G 5/0013

(57) ABSTRACT

Methods and systems for providing status of other aircraft in a vicinity of an operator controlled aircraft. A method of providing status of other aircraft in a vicinity of an operator controlled aircraft include displaying an operator controlled aircraft icon on a display to represent positioning of the operator controlled aircraft. Radio transmissions from the other aircraft are processed to generate corresponding text. The text is processed to determine at least one of an identifier of the other aircraft, a position of the other aircraft, or an intent of the other aircraft. An aircraft icon representing the other aircraft indicative of at least one of the position of the other aircraft, the identifier of the other aircraft, or the intent of the other aircraft is displayed on a display.

### CROSS-REFERENCES TO OTHER APPLICATIONS

This application claims benefit under 35 USC§ 119(e) to U.S. Provisional Patent Application No. 63/444,194 filed Feb. 8, 2023, and entitled “System and Techniques for Improved Situational Awareness,” the disclosure of which is incorporated by reference herein in its entirety for all purposes.

### BACKGROUND

Remotely piloted and autonomous aerial vehicles may be operated in congested airspace, such as in an airport environment. An operator monitoring or controlling multiple aerial vehicles at a given time may need to maintain situational awareness of other aircraft in the vicinity. At uncontrolled airfields (e.g., airfields without a control tower or with a tower that is closed), pilots typically transmit the position of their aircraft and/or their intentions over a radio frequency to support the maintenance of safe separation between the aircraft in the vicinity. Where an operator monitors and/or controls more than one aerial vehicle, the increased workload may increase the risk that the operator becomes task-saturated and loses situational awareness for one or more of the aircraft in the vicinity. Multiple radio frequencies may also need to be monitored simultaneously, which may be difficult for a single operator to manage in combination with attending other tasks.

Traditional aviation relies heavily on verbal radio communication to broadcast pilot intent, monitor the position and intent of aircraft in the vicinity, broadcast air traffic control (ATC) or control tower communications, request clearances, receive authorization, and receive new instructions to comply with. The radio communications enhance situational awareness by augmenting what can be visually seen from the cockpit, or if equipped, ADS-B in an Automatic Dependent Surveillance-Broadcast (ADS-B) receiver display. ADS-B is an advanced surveillance technology that combines an aircraft's positioning source, aircraft avionics, and a ground infrastructure to create an accurate surveillance interface between aircraft and air traffic control (ATC). A pilot of a conventional aircraft, however, is only required to monitor one frequency at a time and is only flying one aircraft at a time.

In contrast, a Multi Vehicle Supervisor (MVSor) may need to listen to multiple (e.g., up to three or more) simultaneous radio frequencies, and interpret that information for situational awareness of surrounding traffic in multiple different operating areas, all while monitoring multiple aircraft systems. Because the workload for a MVSor may increase substantially in off-nominal situations or emergency situations, the MVSor may have substantially reduced mental bandwidth and attention for processing and interpreting such multiple radio transmissions.

One of the biggest challenges for an MVSor is to monitor multiple different common traffic advisory frequencies (CTAF) or universal communication (UNICOM) voice communication frequencies used to declare position and intention information by pilots in a geographic area. Some of these pilots are not under ATC control, and may not be equipped with co-operative equipment such as an ADS-B transmitter or Mode C transponder.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments disclosed herein are directed to systems and methods for enhancing situational awareness of an aircraft operator. In many embodiments, the position of at least one aircraft controlled by the aircraft operator and the position, identity, and/or intent of other aircraft in the vicinity of the operator controlled aircraft are displayed on a display (e.g., using suitable icons and/or text) viewable by the aircraft operator. In many embodiments, radio transmissions broadcast by the other aircraft are processed to generate corresponding text that is processed to determine status information for the other aircraft (for example, identifier of the other aircraft, position of the other aircraft, and/or intent of the operator of the other aircraft). In some embodiments, the status information for the other aircraft is supplemented via air traffic control information for the other aircraft. In many embodiments, the status information for the other aircraft is used to configure the icons and/or text displayed on the display. In some embodiment, filtering and/or decluttering is used to deemphasize or not display status information for other aircraft in the vicinity for which there is currently a low probability of impacting the continued safe flight and/or landing of the operator controlled aircraft. The display of the status information for the other aircraft may greatly increase the situational awareness of the aircraft operator and/or decrease the workload of the aircraft operator-especially when the aircraft operator is simultaneously controlling multiple remotely piloted or autonomous aircraft.

Thus, in one aspect, a computer-implemented method of providing status information of other aircraft in a vicinity of an operator controlled aircraft is provided. The method includes displaying an operator controlled aircraft icon on a display to represent positioning of the operator controlled aircraft within the vicinity of the operator controlled aircraft. Radio transmissions broadcast by the other aircraft in the vicinity of the operator controlled aircraft are received. The radio transmissions are processed to generate one or more text strings corresponding to audio content of the radio transmissions. The one or more text strings are processed to determine, for each of one or more of the other aircraft in the vicinity of the operator controlled aircraft, at least one of an identifier of the other aircraft, a position of the other aircraft, or an intent of the other aircraft. One or more other aircraft icons are displayed on a display. Each of the other aircraft icons is indicative of at least one of the position of one of the other aircraft, the identifier of one of the other aircraft, or the intent of one of the other aircraft.

In some embodiments, the method further includes supplementing the status information for the aircraft in the vicinity. For example, the method can further include receiving air traffic information for at least one of the other aircraft in the vicinity of the operator controlled aircraft obtained from an aircraft traffic information source (e.g., an aircraft traffic information database) via a first wireless transceiver, internet connection, and/or surveillance data provider. The air traffic information can be indicative of positioning of at least one of the other aircraft over a period of time. The method can further include correlating one of the other aircraft icons with one of the other aircraft in the vicinity of the operator controlled aircraft via comparing a position of the other aircraft represented by the other aircraft icon with position data from the air traffic information. The method can further include displaying, on the display, at least one of a position track for the other aircraft represented by the other aircraft icon, a symbol indicating correlation between the other aircraft icon and the position track, or intent information for the other aircraft represented by the other aircraft icon. The air traffic information may include Automatic Dependent Surveillance-Broadcast (ADS-B) data or other surveillance/position system data. The ADS-B data may include at least one of a global positioning system (GPS) location, an altitude, or a ground speed. The correlating may be performed by matching at least a portion of the other aircraft identifier in the one or more text strings and the air traffic information. The method can further include accessing aircraft performance data for one of the other aircraft based on the air traffic information, determining movement of the one of the other aircraft based on the aircraft performance data, determining an updated position of the one of the other aircraft based on the movement, and displaying the updated position of the one of the other aircraft on the display.

The method can employ any suitable approach for processing the one or more text strings. For example, processing the one or more text strings can include performing a keyword search.

The method can employ displaying other information that may improve the situational awareness of the aircraft operator. For example, the method can include displaying one or more aircraft pattern segments on the display for an airport.

The method can include displaying any suitable information regarding the intent of the other aircraft in the vicinity. For example, the displayed intent of the other aircraft may be to accomplish a full stop landing, a touch and go landing, or a go-around. The displayed intent of the other aircraft may be to accomplish an entry into an airport traffic pattern or a departure from an airport traffic pattern. The displayed intent of the other aircraft may include at least one of a positional report, holding, maneuvering, slow flight, or other communication of intent for informing local air traffic, airport tower, or air traffic control.

In some embodiments of the method, the display of the status information for the other aircraft in the vicinity is filtered and/or decluttered to deemphasize other aircraft in the area with a low risk of interfering with continued safe flight and/or landing of the aircraft controlled by the operator. For example, in some embodiments, the method can further include quantifying, for each of the other aircraft in the vicinity of the operator controlled aircraft, a relative chance of needing to alter a current flight path of the operator controlled aircraft based on a determined flight trajectory and/or intent of the other aircraft. The method can further include determining, for each of the other aircraft in the vicinity of the operator controlled aircraft, whether the relative chance of needing to alter the current flight path of the operator controlled aircraft is below a threshold. The display of the other aircraft icons for the other aircraft for which the relative chance of needing to alter the current flight path of the operator controlled aircraft is below the threshold can be accomplished to focus attention on the other aircraft for which the relative chance of needing to alter the current flight path of the operator controlled aircraft is above the threshold.

In another aspect, a system for providing status information of other aircraft in a vicinity of an operator controlled aircraft includes a radio receiver, a display, at least one processor, and a tangible memory device. The radio receiver is operable to receive radio transmissions broadcast on one or more aviation communication frequencies. The tangible memory device stores non-transitory instructions executable by the at least one processor to cause the at least one processor to: (a) display an operator controlled aircraft icon on the display to represent positioning of the operator controlled aircraft within the vicinity of the operator controlled aircraft, (b) receive radio transmissions broadcast by the other aircraft in the vicinity of the operator controlled aircraft, (c) process the radio transmissions to generate one or more text strings corresponding to audio content of the radio transmissions, (d) process the one or more text strings to determine, for each of one or more of the other aircraft in the vicinity of the operator controlled aircraft, at least one of an identifier of the other aircraft, a position of the other aircraft, or an intent of the other aircraft, and (e) display one or more other aircraft icons on a display, wherein each of the other aircraft icons is indicative of at least one of the position of the other aircraft, the identifier of the other aircraft, or the intent of the other aircraft.

In some embodiments, the system is configured to supplement the status information for the aircraft in the vicinity. For example, the instructions can further be executable by the at least one processor to cause the at least one processor to: (a) receive air traffic information for at least one of the other aircraft in the vicinity of the operator controlled aircraft obtained from an aircraft traffic information source (e.g., an aircraft traffic information database) via a first wireless transceiver, internet connection, and/or surveillance data provider, wherein the air traffic information is indicative of positioning of at least one of the other aircraft over a period of time; (b) correlate one of the other aircraft icons with one of the other aircraft in the vicinity of the operator controlled aircraft via comparing a position of the other aircraft represented by the other aircraft icon with position data from the air traffic information; and (c) display, on the display, at least one of a position track for the other aircraft represented by the other aircraft icon, a symbol indicating correlation between the other aircraft icon and the position track, or intent information for the other aircraft represented by the other aircraft icon. The air traffic information may include Automatic Dependent Surveillance-Broadcast (ADS-B) data or other surveillance/position system data. The ADS-B data may include at least one of a global positioning system (GPS) location, an altitude, or a ground speed. The correlation of one of the other aircraft icons with one of the other aircraft in the vicinity of the operator controlled aircraft correlating is accomplished via matching at least a portion of the other aircraft identifier in the one or more text strings and the air traffic information. The instructions can be further executable by the at least one processor to cause the at least one processor to: (a) access aircraft performance data for one of the other aircraft based on the air traffic information; (b) determine movement of the one of the other aircraft based on aircraft performance data for the other aircraft; (c) determine an updated position of the one of the other aircraft based on the movement; and (d) display the updated position of the one of the other aircraft on the display.

The system can employ any suitable approach for processing the one or more text strings. For example, system can be configured to process the one or more text strings using a keyword search.

The system can display other information that may improve the situational awareness of the aircraft operator. For example, the system can be configured to display one or more aircraft pattern segments on the display for an airport.

The system can be configured to display any suitable information regarding the intent of the other aircraft in the vicinity. For example, the displayed intent of the other aircraft may be to accomplish a full stop landing, a touch and go landing, or a go-around. The displayed intent of the other aircraft may be to accomplish an entry into an airport traffic pattern or a departure from an airport traffic pattern. The displayed intent of the other aircraft may include at least one of a positional report, holding, maneuvering, slow flight, or other communication of intent for informing local air traffic, airport tower, or air traffic control.

In some embodiments of the system, the display of the status information for the other aircraft in the vicinity is filtered and/or decluttered to deemphasize other aircraft in the area with a low risk of interfering with continued safe flight and/or landing of the aircraft controlled by the operator. For example, the instructions can be further executable by the at least one processor to cause the at least one processor to: (a) quantify, for each of the other aircraft in the vicinity of the operator controlled aircraft, a relative chance of needing to alter a current flight path of the operator controlled aircraft based on a determined flight path of the other aircraft; and (b) determine, for each of the other aircraft in the vicinity of the operator controlled aircraft, whether the relative chance of needing to alter the current flight path of the operator controlled aircraft is below a threshold. The display of the other aircraft icons for the other aircraft for which the relative chance of needing to alter the current flight path of the operator controlled aircraft is below the threshold is accomplished to focus attention on the other aircraft for which the relative chance of needing to alter the current flight path of the operator controlled aircraft is above the threshold.

In an aspect of the disclosure a non-transitory computer-readable medium storing a plurality of instructions that, when executed by one or more processors of a computing device, cause the one or more processors to perform operations of any of the methods described above.

### BRIEF DESCRIPTION OF THE DRAWINGS

FIG. 1 illustrates an exemplary display for techniques for improved situational awareness, in accordance with embodiments.

FIG. 2 illustrates a system logic flowchart for techniques for improved situational awareness, in accordance with embodiments.

FIG. 3 illustrates an exemplary system for providing status information of other aircraft in a vicinity of an operator controlled aircraft, in accordance with embodiments.

FIG. 4 illustrates a flowchart of a method of providing status information of other aircraft in a vicinity of an operator controlled aircraft.

FIG. 5 illustrates a flowchart of an approach that can be used in the method of FIG. 4 to filter and/or declutter the status information of the other aircraft in the vicinity to deemphasize other aircraft in the area with a low risk of interfering with continued safe flight and/or landing of the operator controlled aircraft.

FIG. 6 illustrates an exemplary computing system for the system of FIG. 3.

### DETAILED DESCRIPTION OF THE INVENTION

Techniques and systems described herein allow for improved situational awareness, specifically in an airport environment. A computing system can receive input (e.g., one or more text strings) from a radio transmission from aircraft. In various embodiments, adapters can be spliced into the radio ports that can convert the voice to digital. The voice-to-text conversion would be completed by any suitable application. The computing system can process the one or more text strings to determine one or more of: an aircraft identifier, an aircraft position, and an intent of the pilot of the aircraft. The computing system can display an icon on a display that represents the position of the aircraft. Along with the icon, the computing system can display an indication of the intent of the pilot of the aircraft.

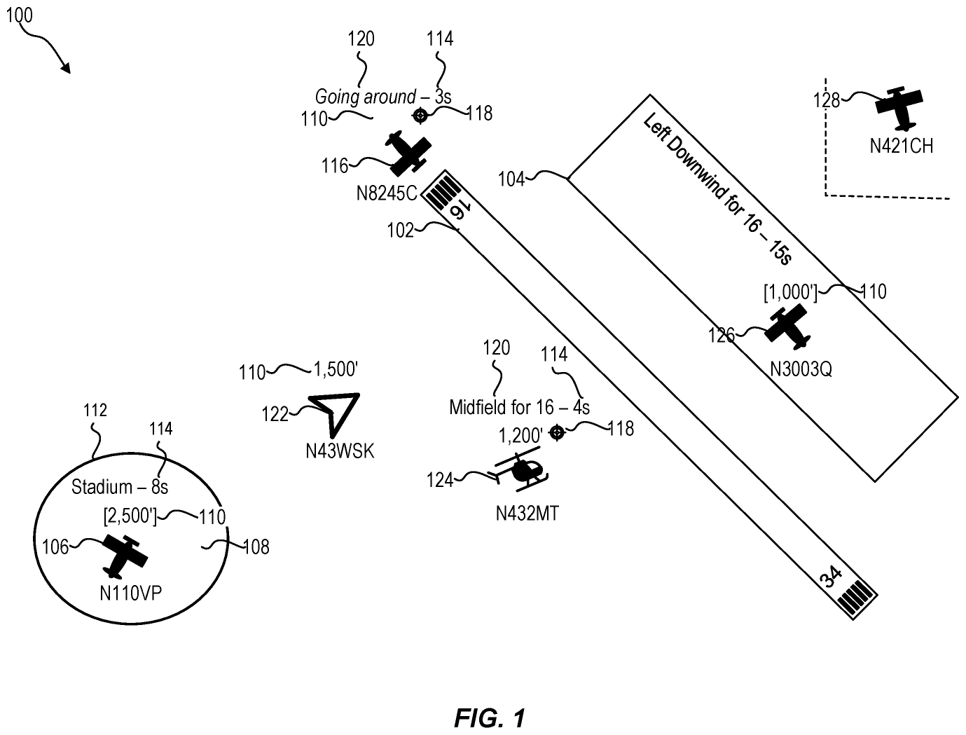

FIG. 1 illustrates an exemplary illustration of a graphical representation 100 for improving situational awareness. The graphical representation 100 can be a dedicated display or an overlay on another display.

The graphical representation 100 can include an illustration of one or more runways 102. The graphical representation 100 can illustrate one or more areas 104 around the runways 102. The areas 104 can include upwind, crosswind, downwind, base, and final orientations of aircraft with respect to a given runway 102.

The graphical representation 100 can include a plurality of fixed wing aircraft, rotary wing aircraft, and autonomous aerial vehicle aircraft. The pilots for the fixed wing and rotary wing aircraft can make radio transmissions to notify other pilots, airport control towers, or air traffic control of their aircraft's position and intent. The number and description of the following aircraft radio transmissions is merely exemplary and not limitation to the scope of the disclosure.

For example, a pilot of the first aircraft 106, may make the following transmission: “Clearwater Traffic, November 1-1-0-Victor-Papa is over stadium at 2500.” The system can receive the transmission and translate the transmission into text data such as tail number: N110VP; altitude: 2500 mean sea level (MSL); position: Stadium waypoint; intent: unknown.

The transmission may be made to an uncontrolled field as normally calls would be made to an air traffic control facility (e.g., a tower). The first portion (“Clearwater Traffic”) identifies which airport the first aircraft 106 is nearby. Here, the first aircraft 106 is in the vicinity of the Clearwater airport. The aircraft call sign is next. “N110VP” is the Federal Aviation Administration (FAA) registration number, also known as a tail number, for the aircraft. It is normally written in large letters on the fuselage of the aircraft. Often pilots and air traffic controllers shorten the callsign to the last three characters of the registration number. Therefore, “N110VP” can be shortened to “0VP.” Voice recognition would also help with follow on calls that are not identified by the full tail number to process updates. For example, while transcribing a transmission that indicates “0VP”, the system may identify the full tail number as “N110VP” based on the tail numbers of aircraft in the vicinity and indicate the full tail number in the transcription.

The system can check ADS-B data feeds for that tail number and location. If there is not a match or partial match of the tail number and not finding a target track, the system can display the icon of an aircraft type based on the tail number registry, with a shaded radius of location uncertainty in the waypoint area (e.g., “stadium” in this exemplary transmission).

The “stadium” portion of the transmission identifies a known geographic position 108 the first aircraft 106 is nearby. As this position may not be precise, the system can note the position with visual cues, such as a shaded or a particular color area 112.

Finally, the last portion of the transmission, “2500” indicates the altitude 110 of the aircraft. The altitude 110 is normally reported with reference to mean sea level (MSL) using a local altimeter setting. In some cases, the altitude can be reported as an above ground level altitude. The altitude 110 can be noted with symbols (e.g., in brackets) to indicate it may not be precise.

A timer 114 can display the number of seconds since the last transmission update from the first aircraft 106. This may indicate the reliability of the displayed information. For example, information with a recent time display may be more reliable than information with an earlier time display. After a predetermined amount of time without subsequent transmission the first aircraft 106 can be removed from the graphical representation 100.

In the exemplary transmission, the pilot of the first aircraft 106 does not state an intent. Some potential intents may include but are not limited to “inbound for landing,” “practicing maneuvers,” or “departing the area.”

FIG. 1 illustrates a second aircraft 116 with the registration number of “N8245C.” A pilot of the second aircraft 116 has transmitted a voice call over local Common Traffic Advisory Frequency (CTAF). The call can be “Clearwater Traffic, 4 5 Charlie is going around.”

The system can translate this into text data tail number: ending in 45C. The altitude: is unknown but likely the altitude is between ground level altitude and the aircraft traffic pattern altitude (normally 1,000 feet above ground level). The position can be determined as on final approach or over the active runway “16” illustrated in FIG. 1 as the runway 102. The system can determine the active runway based on reported winds. Automated weather reports may provide this information. Aircraft generally takeoff and land into the wind and the active runway would have the best headwind component or perhaps minimize the crosswind component. The system can also determine the active runway based on previous traffic calls that announce the active runway. For example, other pilots may announce “Clearwater Traffic, N4922D on final for landing full stop 16.” The “16” from this previous transmission can indicate the active runway, specifically runway “16.” Recent ADS-B tracks can also indicate the active runway in use.

After checking ADS-B data feeds for the registration number for the second aircraft 116, the system can determine a location for an aircraft matching a location and registration number the second aircraft 116. The system can display an icon of a general aviation aircraft based on the tail number registry, along with the ADS-B GPS position and precise altitude and annotates the track with the intent “going around.” In various embodiments, radar data can also be used to correlate position in addition to or in place of ADS-B when available. An icon 118 (e.g., a crosshair icon) can indicate that an associated ADS-B track is matched with this voice transmission and that the system is providing precise position and altitude 110 information. The intent 120 “going around” can be displayed as the timer 114 indicating the last transmission.

The system can also display one or more autonomous or semi-autonomous vehicles. A first aerial vehicle 122, having a registration number of N43WSK, can be displayed using position telemetry for one of the electric vertical takeoff and land (eVTOL) the MVSor is monitoring. All aircraft in the MVSor's control may be displayed using position telemetry. This way, the MVSor may identify the aircraft in his/her control with a single glance at the display. Fusing this information with the surrounding air traffic picture can provide excellent situational awareness and allows the MVSor to focus on relevant nearby traffic, with automated threshold-based alerts. An altitude 110 of the first aerial vehicle 122 can be displayed.

FIG. 1 illustrates a third aircraft 124 displayed on the graphical representation 100. The third aircraft 124 has the registration number N432MT. A pilot can transmit the following transmission: “Clearwater traffic, helicopter 2 Mike Tango is crossing midfield for 16”. The system can translate this into text data including a registration number: ending in 2MT; an altitude: unknown; a position: midfield crossing to runway “16”, intent: implied pattern entry on downwind after crossing midfield. After checking ADS-B data feeds for that tail number and location and finding a matching track for N432MT, the system can display the icon of a helicopter based on the tail number registry information and traffic call, along with the ADS-B information. An icon 118 can indicate that an associated ADS-B track is matched with this voice transmission and that the system is providing precise position and altitude 110 information.

The system can use GPS position and precise altitude information to plot the position of the third aircraft 124. The system can annotate the track with the intent 120 of “crossing midfield.” The timer 114 can be displayed indicating the last transmission by the third aircraft 124.

FIG. 1 further illustrates a fourth aircraft 126 with a registration number of N3003Q on the graphical representation 100. The pilot for the fourth aircraft 126 can transmit “Clearwater traffic, 03Q on downwind for 16.” The system can translate this transmission into text data including: a registration number: ending in 03Q; altitude: unknown, implied pattern altitude; position: downwind leg for runway “16”, intent: pattern approach for landing on runway “16”. After checking ADS-B data feeds for the registration number and location and not finding a target track, the system displays the aircraft icon, with a shaded area 104 of the downwind pattern leg for runway “16”. The altitude 110 can be illustrated in brackets because the altitude information may not be precise.

If precise location information is not available, the system can estimate a ground speed for the fourth aircraft 126 in the traffic pattern using information in the aircraft registry and correlating to the appropriate Pilot Operating Handbook. For example, a Cessna 172 may have a downwind speed between 80 and 90 knots. In contrast a Cirrus SR22T aircraft may be flown downwind at a faster speed of 100 knots. The length of the runway at the aircraft is known. Therefore, the runway length can be divided by the aircraft ground speed on downwind to determine a potential time the fourth aircraft 126 spends on downwind. For example, for an aircraft with a 90-knot ground speed, the aircraft would take approximately 32 seconds on downwind for a runway with a length of 5,000 feet. Shorter runways, faster aircraft could reduce the time the fourth aircraft 126 spends on downwind. After a predetermined amount of time, the system may indicate that the fourth aircraft 126 has turned to the base leg.

FIG. 1 further illustrates a fifth aircraft 128 with a registration number of N421CH on the graphical representation 100. The pilot of the fifth aircraft 128 can transmit “Arcadia Traffic, November 4 2 1 Charlie Hotel on base for 14.” The system can translate this into text data including: the registration number: N421CH; altitude: unknown, implied pattern altitude; position: base leg for runway “14”, intent: pattern approach for landing on runway “14” at Arcadia Municipal. The aircraft icon would not be displayed in this view as it is not in the operating environment relevant to MVSor's current operations. The information may be received because another airport environment happens to share the CTAF frequency and is within range of radio transmissions. This position data and log can be part of the backend database for use with other MVSors if needed and relevant but would be filtered from display on this level of zoom and display.

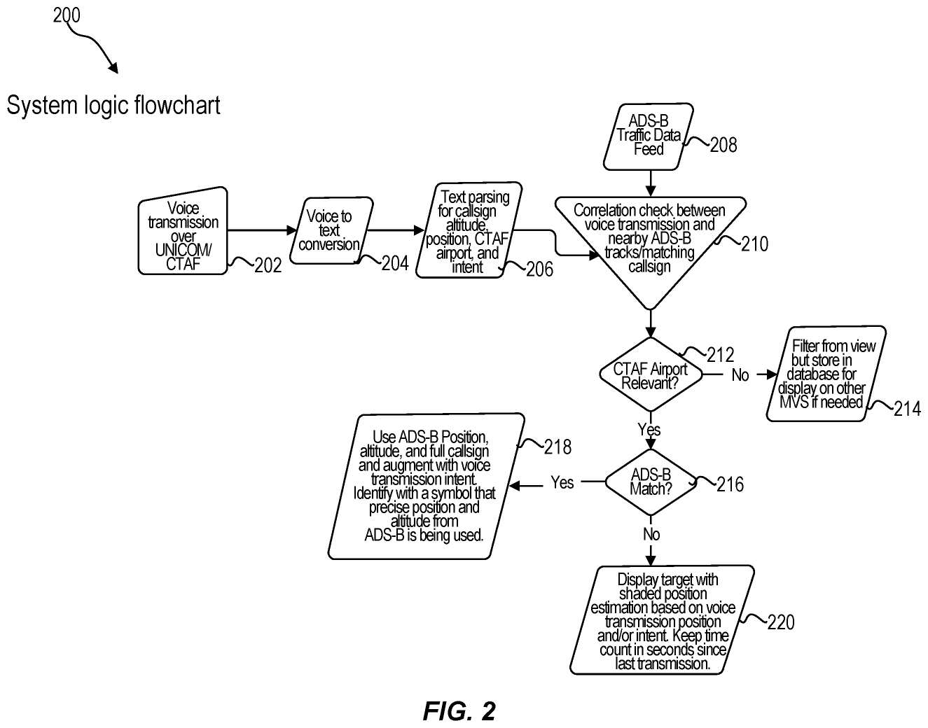

FIG. 2 illustrates an exemplary system logic flowchart illustrating a process 200 according to embodiments of the disclosure.

At block 202, process 200 can include receiving a voice transmission over an aviation communication frequency. The transmission can be in a Very High Frequency (VHF) band. The aviation communication frequency can be a CTAF. The aviation communication frequency can be a tower frequency after normal operating hours for the airfield control tower. The aviation communication frequency can be an approach frequency. The aviation communication frequency can be a center frequency. The aviation communication frequency can be a departure frequency. The voice transmission can be captured as an audio file.

At block 204, process 200 can include converting the voice transmission or the audio file into one or more blocks of text. The one or more blocks of text can be stored in a memory.

At block 206, process 200 can include parsing the one or more blocks of text to identify one or more of an aircraft callsign (e.g., a registration number in whole or in part), an aircraft altitude, an aircraft position, an airport name, and an intent of the pilot. The parsed information can be stored in a memory of the computing system. Metadata can be used to link the one or more parsed blocks of text or aircraft information to the voice transmission.

At block 208, process 200 can include receiving aircraft traffic data feed. In various embodiments the aircraft data feed can include ADS-B data.

At block 210, process 200 can include correlating the aircraft callsign with aircraft information in the aircraft traffic data feed. A matching algorithm can be used to match the callsign (e.g., registration number in whole or in part) with aircraft in the area local to the airport. The process 200 can include storing an association between the aircraft callsign and one of the tracks in the aircraft traffic data feed.

At block 212, process 200 can include determining if the aircraft callsign is relevant to the airport being used for operations. As the common traffic advisory frequencies or UNICOM frequencies can be used by aircraft at different airports, traffic calls being made by aircraft for other airports may not be relevant to the aircraft monitored by the MVSor. At block 214, process 200 can filter non-relevant aircraft from display. The filtered aircraft information can be stored in a memory or a database. The filtered information can be displayed to another MVSor if necessary. In some embodiments, the filtered information may be displayed on demand.

At block 216, process 200 can include determining if the aircraft callsign matches an aircraft track in the vicinity of the airport.

At block 218 (e.g., “YES” at step 216, indicating the aircraft callsign matches an aircraft track in the vicinity of the airport), process 200 can include augmenting aircraft traffic feed data for aircraft position, altitude, and full callsign (registration number) with intent from voice transmission. If the aircraft is matched with an aircraft track in the aircraft data feed, then a symbol can be displayed to indicate that precise position and altitude from the aircraft traffic feed are being used.

At block 220 (e.g., “NO” at step 216, indicating the aircraft callsign does not match an aircraft track in the vicinity of the airport), process 200 can include displaying target with shaded position estimated based on voice transmission position and/or stated intent. A timer can be displayed to display seconds since the last voice transmission.

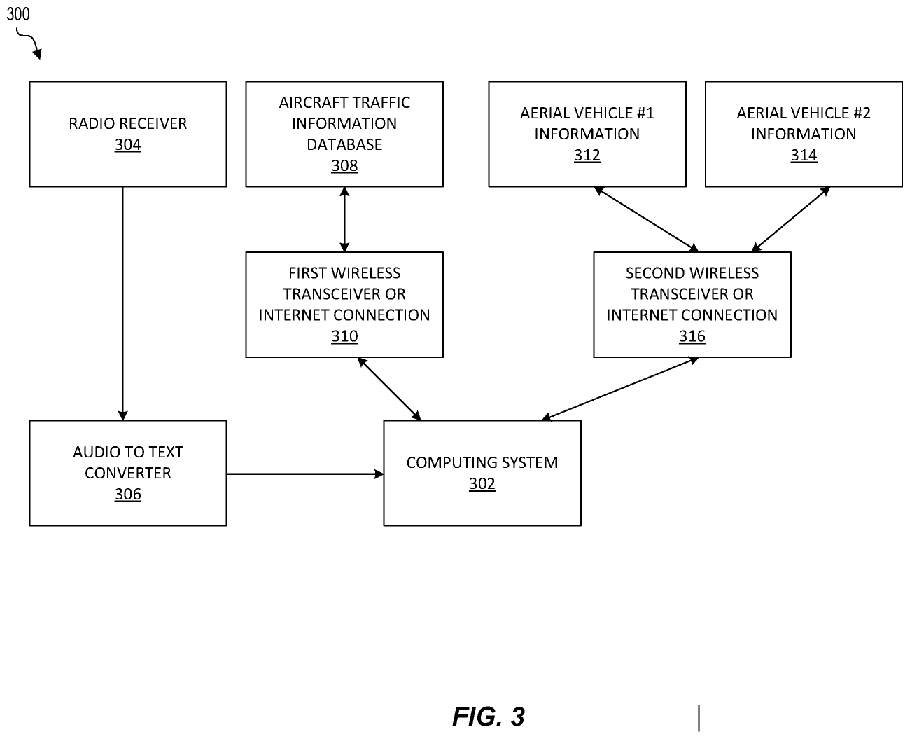

FIG. 3 illustrates an exemplary system 300 for improved situational awareness. The system can include various components that can include a computing system 302, a radio receiver 304, and aircraft traffic information database 308, a first wireless transceiver or internet connection 310, and a second wireless transceiver or internet connection 316. The radio receiver 304 can receive a radio transmission in the VHF frequency band. The radio receiver 304 can store the radio transmission as an audio file.

An audio to text converter 306 can be a routine that can convert the audio file to a text file. The text file can be stored in a memory of the computing system 302.

An aircraft traffic information database 308 can store a plurality of aircraft information. One such aircraft traffic information database 308 can be Automatic Dependent Surveillance-Broadcast (ADS-B). ADS-B is an automatic service because it periodically transmits information without the need for pilot or operator involvement. ADS-B can be dependent on GPS or other suitable navigation systems, such as a Flight Management System (FMS), for position and ground speed, and is considered surveillance because of the method of determining 3D position and identification of aircraft and other objects. The information the system transmits, such as aircraft position, altitude, ground speed and callsign, is available to anyone with suitable receiving equipment or an internet connection to a provider. This makes it a useful tool for aircraft operators and air traffic controllers globally in navigating the increasingly busy airspace.

ADS-B provides aircraft surveillance data that can be used by Air Traffic Management and other aircraft, to track the position of an aircraft in the airspace at any given time. ADS-B tracking relies on a Mode S 1090ES transponder, Global Navigation Satellite System (GNSS) and the deployment of ground or satellite-based surveillance systems.

Aircraft equipped with ADS-B OUT systems transmit data using the 1090 MHz frequency via squitters—burst transmissions sent periodically by the Mode S transponder. This data can be received by air traffic controllers, and other aircraft that are fitted with transponders with ADS-B IN capability.

1090 MHz is the internationally approved frequency to transmit Mode-S replies and ADS-B data. In certain airspace, specifically the US airspace, aircraft flying under 18,000 FT MSL can broadcast data using the 978 MHz—the Universal Access Transceiver (UAT)—frequency. This is largely due to the high volume of general aviation aircraft that fly in the US airspace compared to other regions. Both 1090 MHz and 978 MHz channels can receive traffic (TIS-B) and weather (FIS-B) data.

The first wireless transceiver or internet connection 310 can be configured to receive an aircraft data stream from the aircraft traffic information database 308. The first wireless transceiver or internet connection 310 can operate on a frequency band of 978 MHz-1090 MHz. The first wireless transceiver or internet connection 310 can also send aircraft registration number, GPS position, and velocity data to the aircraft traffic information database 308. The first wireless transceiver or internet connection 310 can send and receive data from the computing system 302.

A second wireless transceiver or internet connection 316 can send and receive data from a plurality of aerial vehicles (e.g., aerial vehicle #1 312 and aerial vehicle #2 314). The data can include control data for the aerial vehicles. The data can include position, velocity, and acceleration data from the plurality of aerial vehicles. The second wireless transceiver or internet connection 316 can send and receive data from the computing system 302. While ADS-B is described as one source of aircraft information, the disclosure is not limited to the use of ADS-B. Other air data systems in use or being developed for future use can be used to provide the aircraft information.

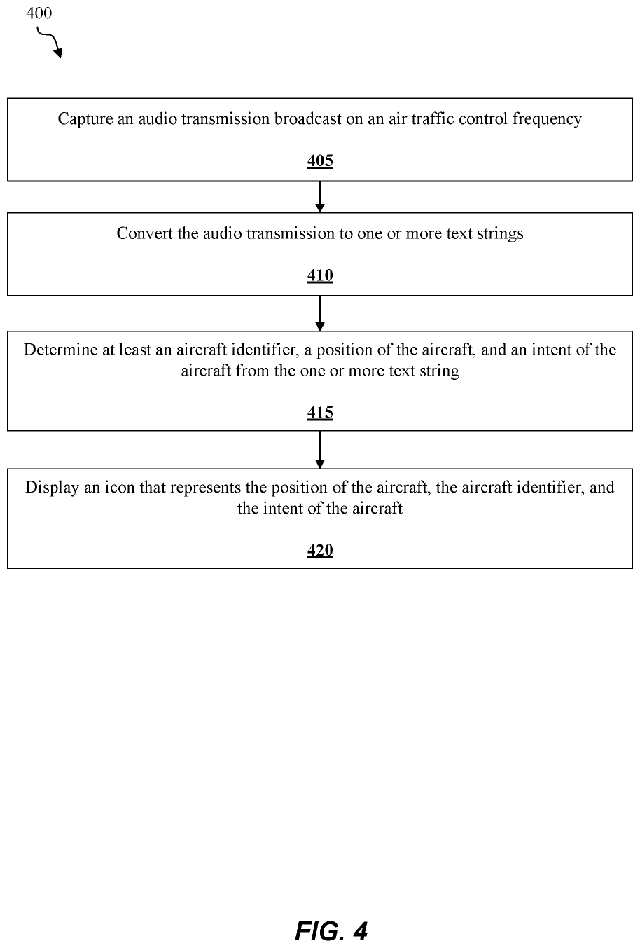

FIG. 4 is a flow chart of a process 400, according to an example of the present disclosure. According to an example, one or more process blocks of FIG. 4 may be performed by a computing system.

At block 405, process 400 may include capturing an audio transmission broadcast on an aviation communication frequency. For example, a computing system may capture an audio transmission broadcast on an aviation communication frequency, as described above.

At block 410, process 400 may include converting the audio transmission to one or more text strings. For example, a computing system may convert the audio transmission to one or more text strings, as described above.

At block 415, process 400 may include determining one or more of an aircraft identifier, a position of the aircraft, and an intent of the aircraft from the one or more text string. For example, a computing system may determine one or more of an aircraft identifier, a position of the aircraft, and an intent of the aircraft from the one or more text string, as described above.

At block 420, process 400 may include displaying an icon that represents one or more of the position of the aircraft, the aircraft identifier, and the intent of the aircraft on display device. For example, a computing system may display an icon that represents the position of the aircraft, the aircraft identifier, and the intent of the aircraft on a graphical representation provided on a display device, as described above.

In various embodiments, a computing system can include one or more memories; and one or more processors in communication with the one or more memories and configured to execute instructions stored in the one or more memories to perform operations of process 400 as described above.

In various embodiments, a computer-readable medium stores a plurality of instructions that, when executed by one or more processors of a computing system, cause one or more processors to perform operations of any of the methods of process 400 as described above.

It should be noted that while FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In various embodiments, process 400 can include receiving aircraft information for one or aircraft from a receiver, wherein the aircraft information can generate aircraft tracks on a display. The process 400 can include correlating the icon with at least one of the aircraft tracks by comparing position data from the aircraft information. When the icon and at least one of the aircraft tracks matches, process 400 can include displaying track information, a symbol indicating that the track is correlated, and aircraft intent information on the display.

In various embodiments, the aircraft information comprises Automatic Dependent Surveillance-Broadcast data. The Automatic Dependent Surveillance-Broadcast data can include one or more of aircraft GPS location, aircraft altitude, and aircraft ground speed. In various embodiments, this technology can also utilize other traffic data feeds such as radar, telemetry from UAS or AAM aircraft, etc.

In various embodiments, the determining at least an aircraft identifier, a position of the aircraft, and an intent of the aircraft from the one or more text string is performed by a keyword search.

In various embodiments, correlating is performed by matching at least a portion of the aircraft identifier in the one or more text strings and the aircraft information. In various embodiments, the correlating is performed by matching at least a portion of the aircraft identifier and a spoken position in the voice transmission and the aircraft information

In various embodiments, process 400 can include displaying one or more aircraft pattern segments on the display for an airport.

In various embodiments, an intent of the aircraft includes at least one of a full stop landing, a touch and go landing, or a go-around. In various embodiments, an intent of the aircraft includes at least one of an entry into an airport traffic pattern or a departure from an airport traffic pattern.

In various embodiments, process 400 can include accessing aircraft performance data for an aircraft based on the aircraft information. The process 400 can include determining movement of the aircraft based on the aircraft performance data. The process 400 can include displaying an updated position of the aircraft based on the movement.

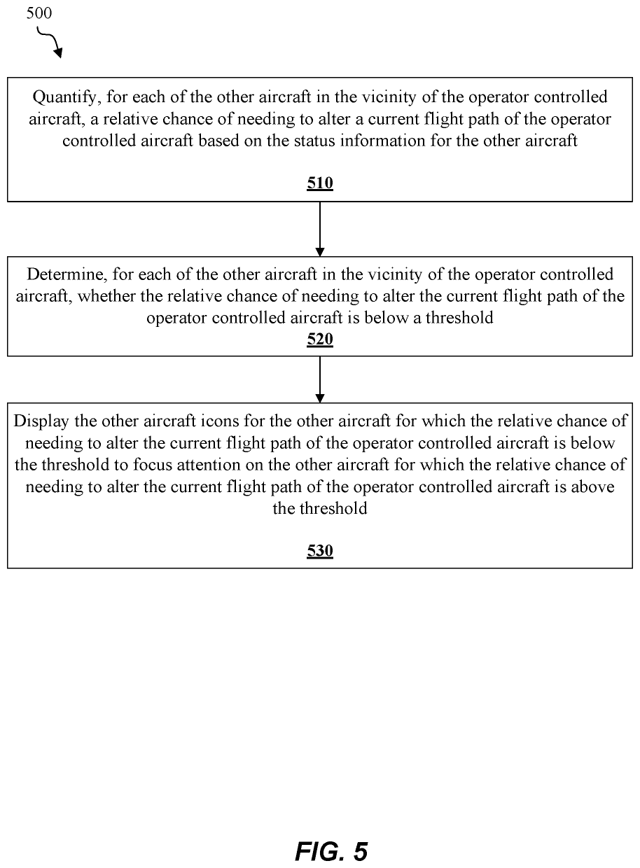

FIG. 5 illustrates a flowchart of a process 500 that can be used in conjunction with the process 400 to filter and/or declutter the status information of the other aircraft in the vicinity to deemphasize other aircraft in the area with a low risk of interfering with continued safe flight and/or landing of the operator controlled aircraft. Deemphasizing the other aircraft in the vicinity with a low risk can help to reduce human factors task workload and distraction.

At block 510, a relative risk of needing to alter a current flight path of the operator controlled aircraft is quantified based on the status information of the other aircraft. Any suitable approach can be used to quantify the relative risk. For example, the relative risk can be based upon any suitable combination of: (a) the current position of the other aircraft relative to the operator controlled aircraft, (b) the current direction of the other aircraft relative to the operator controlled aircraft, (c) the current altitude and/or rate of change in altitude of the other aircraft relative to the operator controlled aircraft, (d) a current closing rate between the other aircraft and the operator controlled aircraft, and (e) a projected future position of the other aircraft relative to the operator controlled aircraft. The intent of the other aircraft may be used to improve prediction of the future position of the other aircraft. Each of the parameters considered can be used to generate a risk number for use in determining whether to deemphasize the other aircraft if the relative risk is low.

At block 520, the relative risk determined in block 510 is compared to a suitable threshold to identify a subset of the other aircraft that pose a near-term low risk of interfering with continued safe flight and/or landing of the operator controlled aircraft. In some embodiments, the threshold can be adjusted to some extent based on the number of the other aircraft in the vicinity to limit the total number of other aircraft icons displayed while still displaying other aircraft icons for all of the other aircraft for which the aircraft operator should be apprised of the corresponding status information for safe operation of the operator controlled aircraft.

At block 530, the display of the other aircraft icons with a relative risk below the threshold is attenuated or discontinued to focus attention on the other aircraft with a relative risk above the threshold. Any suitable approach can be used to attenuate the display of the other aircraft icons for the other aircraft with a relative risk below the threshold. Alternatively, the display of the other aircraft icons for the other aircraft with a relative risk above the threshold can be emphasized (e.g., higher intensity, bold text, flashing display, etc.).

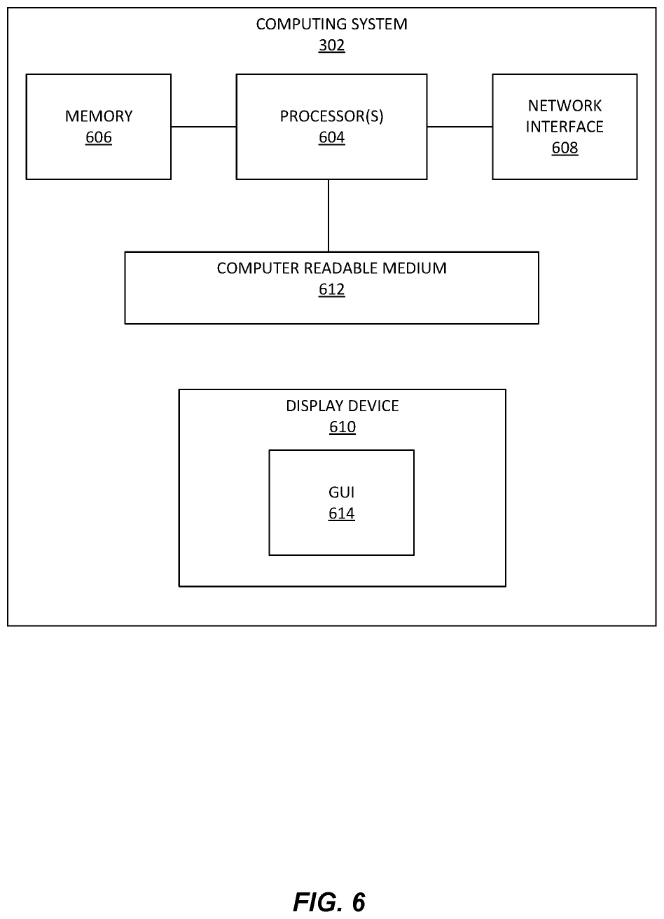

FIG. 6 illustrates an exemplary computing system 302 that may be used to implement various embodiments described herein. The computing system 302 is shown as comprising one or more processors 604, a system memory 606 (which may comprise any combination of volatile and/or non-volatile memory such as, for example, buffer memory, RAM, DRAM, ROM, flash, or any other suitable memory device), and a network interface (e.g., an external communication interface). Moreover, one or more of the modules may be disposed within one or more of the components of the system memory 606 or may be disposed externally. The software and hardware modules shown in FIG. 6 are provided for illustration purposes only, and the configurations are not intended to be limiting. The processors 604, system memory 606 and/or external communication interface 608 may implement the above-described method(s).

The external communication interface 608 may be configured or programmed to receive and generate electronic messages comprising information transmitted through the computing system 302 to or from the plurality of autonomous aircraft. When an electronic message is received by the computing system 302 via external communication interface 608, it may be processed, and relevant information (e.g., the graphical representation 100) may be displayed on the display device 610 via the graphical user interface (GUI) 614.

Electronic components of the described embodiments may be specially constructed for the required purposes or may comprise one or more general-purpose computers selectively activated or reconfigured by a computer program stored in the computer. Such a computer program may be stored in a computer readable storage medium 612, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom,” “top” or “side” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

For simplicity, various active and passive circuit components are not shown in the figures. In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

While the invention has been described with reference to specific embodiments, those skilled in the art with access to this disclosure will appreciate that variations and modifications are possible.

It should be understood that all numerical values used herein are for purposes of illustration and may be varied. In some instances, ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure can be modified or omitted and that other elements not shown or described can be added.

The above description is illustrative and is not restrictive. Many variations of the invention will become apparent to those skilled in the art upon review of the disclosure. The scope of patent protection should, therefore, be determined not with reference to the above description, but instead should be determined with reference to the following claims along with their full scope or equivalents.

What is claimed is:

1. A computer-implemented method of providing status information of other aircraft in a vicinity of an operator controlled aircraft, the method comprising:
displaying an operator controlled aircraft icon on a display to represent positioning of the operator controlled aircraft within the vicinity of the operator controlled aircraft;
receiving radio transmissions broadcast by the other aircraft in the vicinity of the operator controlled aircraft;
processing the radio transmissions to generate one or more text strings corresponding to audio content of the radio transmissions;
processing the one or more text strings to determine, for each of one or more of the other aircraft in the vicinity of the operator controlled aircraft, at least one of an identifier of the other aircraft, a position of the other aircraft, or an intent of the other aircraft; and
displaying one or more other aircraft icons on a display, wherein each of the other aircraft icons is indicative of at least one of the position of one of the other aircraft, the identifier of one of the other aircraft, or the intent of one of the other aircraft.

2. The method of claim 1, further comprising:
receiving air traffic information for at least one of the other aircraft in the vicinity of the operator controlled aircraft obtained from an aircraft traffic information source via a first wireless transceiver, internet connection, or surveillance data provider, wherein the air traffic information is indicative of positioning of at least one of the other aircraft over a period of time;
correlating one of the other aircraft icons with one of the other aircraft in the vicinity of the operator controlled aircraft via comparing a position of the other aircraft represented by the other aircraft icon with position data from the air traffic information; and
displaying, on the display, at least one of a position track for the other aircraft represented by the other aircraft icon, a symbol indicating correlation between the other aircraft icon and the position track, or intent information for the other aircraft represented by the other aircraft icon.

3. The method of claim 2, wherein the air traffic information comprises Automatic Dependent Surveillance-Broadcast (ADS-B) data or other surveillance/position system data.

4. The method of claim 3, wherein ADS-B data comprises at least one of a global positioning system (GPS) location, an altitude, or a ground speed.

5. The method of claim 2, wherein correlating is performed by matching at least a portion of the other aircraft identifier in the one or more text strings and the air traffic information.

6. The method of claim 2, further comprising:
accessing aircraft performance data for one of the other aircraft based on the air traffic information;
determining movement of the one of the other aircraft based on the aircraft performance data;
determining an updated position of the one of the other aircraft based on the movement; and
displaying the updated position of the one of the other aircraft on the display.

7. The method of claim 1, wherein processing the one or more text strings comprises performing a keyword search.

8. The method of claim 1, further comprising displaying one or more aircraft pattern segments on the display for an airport.

9. The method of claim 1, wherein an intent of the other aircraft includes at least one of a full stop landing, a touch and go landing, or a go-around.

10. The method of claim 1, wherein an intent of the other aircraft includes at least one of an entry into an airport traffic pattern or a departure from an airport traffic pattern.

11. The method of claim 1, wherein an intent of the other aircraft includes at least one of a positional report, holding, maneuvering, slow flight, or other communication of intent for informing local air traffic, airport tower, or air traffic control.

12. The method of claim 1, further comprising:
quantifying, for each of the other aircraft in the vicinity of the operator controlled aircraft, a relative chance of needing to alter a current flight path of the operator controlled aircraft based on a determined flight trajectory and/or intent of the other aircraft; and
determining, for each of the other aircraft in the vicinity of the operator controlled aircraft, whether the relative chance of needing to alter the current flight path of the operator controlled aircraft is below a threshold,
wherein the display of the other aircraft icons for the other aircraft for which the relative chance of needing to alter the current flight path of the operator controlled aircraft is below the threshold is accomplished to focus attention on the other aircraft for which the relative chance of needing to alter the current flight path of the operator controlled aircraft is above the threshold.

13. A system for providing status information of other aircraft in a vicinity of an operator controlled aircraft, the system comprising:
a radio receiver operable to receive radio transmissions broadcast on one or more aviation communication frequencies;
a display;
at least one processor; and
a tangible memory device storing non-transitory instructions executable by the at least one processor to cause the at least one processor to:
display an operator controlled aircraft icon on the display to represent positioning of the operator controlled aircraft within the vicinity of the operator controlled aircraft;
receive radio transmissions broadcast by the other aircraft in the vicinity of the operator controlled aircraft;
process the radio transmissions to generate one or more text strings corresponding to audio content of the radio transmissions;
process the one or more text strings to determine, for each of one or more of the other aircraft in the vicinity of the operator controlled aircraft, at least one of an identifier of the other aircraft, a position of the other aircraft, or an intent of the other aircraft; and
display one or more other aircraft icons on a display, wherein each of the other aircraft icons is indicative of at least one of the position of the other aircraft, the identifier of the other aircraft, or the intent of the other aircraft.

14. The system of claim 13, wherein the instructions are further executable by the at least one processor to cause the at least one processor to:
receive air traffic information for at least one of the other aircraft in the vicinity of the operator controlled aircraft obtained from an aircraft traffic information source via a first wireless transceiver or internet connection, wherein the air traffic information is indicative of positioning of at least one of the other aircraft over a period of time;
correlate one of the other aircraft icons with one of the other aircraft in the vicinity of the operator controlled aircraft via comparing a position of the other aircraft represented by the other aircraft icon with position data from the air traffic information; and
display, on the display, at least one of a position track for the other aircraft represented by the other aircraft icon, a symbol indicating correlation between the other aircraft icon and the position track, or intent information for the other aircraft represented by the other aircraft icon.

15. The system of claim 14, wherein the air traffic information comprises Automatic Dependent Surveillance-Broadcast (ADS-B) data or other surveillance/position system data.

16. The system of claim 15, wherein ADS-B data comprises at least one of a global positioning system (GPS) location, an altitude, or a ground speed.

17. The system of claim 14, wherein the correlation of one of the other aircraft icons with one of the other aircraft in the vicinity of the operator controlled aircraft correlating is accomplished via matching at least a portion of the other aircraft identifier in the one or more text strings and the air traffic information.

18. The system of claim 14, wherein the instructions are further executable by the at least one processor to cause the at least one processor to:
access aircraft performance data for one of the other aircraft based on the air traffic information;
determine movement of the one of the other aircraft based on aircraft performance data for the other aircraft;
determine an updated position of the one of the other aircraft based on the movement; and
display the updated position of the one of the other aircraft on the display.

19. The system of claim 13, wherein processing of the one or more text strings comprises performing a keyword search.

20. The system of claim 13, wherein the instructions are further executable by the at least one processor to cause the at least one processor to display one or more aircraft pattern segments on the display for an airport.

21. The system of claim 13, wherein an intent of the other aircraft includes at least one of a full stop landing, a touch and go landing, or a go-around.

22. The system of claim 13, wherein an intent of the other aircraft includes at least one of an entry into an airport traffic pattern or a departure from an airport traffic pattern.

23. The system of claim 13, wherein an intent of the other aircraft includes at least one of a positional report, holding, maneuvering, slow flight, or other communication of intent for informing local air traffic, airport tower, or air traffic control.

24. The system of claim 13, wherein the instructions are further executable by the at least one processor to cause the at least one processor to:
quantify, for each of the other aircraft in the vicinity of the operator controlled aircraft, a relative chance of needing to alter a current flight path of the operator controlled aircraft based on a determined flight trajectory and/or intent of the other aircraft; and
determine, for each of the other aircraft in the vicinity of the operator controlled aircraft, whether the relative chance of needing to alter the current flight path of the operator controlled aircraft is below a threshold,
wherein the display of the other aircraft icons for the other aircraft for which the relative chance of needing to alter the current flight path of the operator controlled aircraft is below the threshold is accomplished to focus attention on the other aircraft for which the relative chance of needing to alter the current flight path of the operator controlled aircraft is above the threshold.
